(19) United States
(12) Patent Application Publication
(10) Pub. No.: US 2026/0304419 A1
(43) Pub. Date: Oct. 1, 2026

(54) MULTI-DCI BASED SIMULTANEOUS PUSCH TRANSMISSION

(71) Applicant: Apple Inc., Cupertino, CA (US)

(72) Inventors: Chunhai Yao, Beijing (CN); Haitong Sun, Saratoga, CA (US); Dawei Zhang, Saratoga, CA (US); Hong He, San Jose, CA (US); Wei Zeng, Saratoga, CA (US); Seyed Ali Akbar Fakoorian, San Diego, CA (US); Ankit Bhamri, Haar Bavaria (DE)

(21) Appl. No.: 19/100,978

(22) PCT Filed: Aug. 11, 2022
(86) PCT No.: PCT/CN2022/111691

§ 371 Date: Feb. 4, 2025

(51) Int. Cl. H04W 72/1268; H04W 24/10; H04W 56/00; H04W 72/232

(52) U.S. Cl. CPC H04W 72/1268; H04W 24/10; H04W 56/0045; H04W 72/232

(57) ABSTRACT

The present disclosure relates to multi-DCI based simultaneous PUSCH transmission. A network device may be configured to generate a plurality of downlink control information (DCI) for scheduling a simultaneous transmission of a plurality of physical uplink shared channels (PUSCHs) of a wireless device, and to send the plurality of DCI to the wireless device, wherein the simultaneous transmission is configured by the plurality of DCI so that the plurality of PUSCHs to be transmitted by the wireless device are at least partially overlapped in time domain.

### TECHNICAL FIELD

This application relates generally to wireless communication systems, including uplink transmissions.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

A simultaneous uplink transmission is under discussion in recent days, which may be supported by using multi-panel structure of a wireless device. In particular, the wireless device may include multiple antenna panels, each antenna panel including one or more antenna arrays. The antenna panels may be arranged at different locations of the wireless device, for example one antenna panel at the top side of the wireless device and a further antenna panel at the bottom side of the wireless device. By provisioning multiple antenna panels, simultaneous transmission of a plurality of physical uplink shared channels (PUSCHs) from the multiple antenna panels (e.g., one antenna panel transmitting one PUSCH) may be achieved. This helps to increase the uplink transmission throughput and reliability.

In the scenario of simultaneous PUSCH transmission, the scheduling of the simultaneously transmitted PUSCHs may need to be discussed and designed. In this disclosure, it is proposed that multiple downlink control information (DCI) is used for scheduling the simultaneously transmitted multiple PUSCHs.

A network device according to some embodiments of the present disclosure may be configured to generate a plurality of DCI for scheduling a simultaneous transmission of a plurality of PUSCHs of a wireless device, and to send the plurality of DCI to the wireless device. The simultaneous transmission may be configured by the plurality of DCI so that the plurality of PUSCHs to be transmitted by the wireless device are at least partially overlapped in time domain.

A wireless device according to some embodiments of the present disclosure may be configured to report, to a network device, a capability of simultaneous transmission of a plurality of PUSCHs, and to receive, from the network device, a plurality of DCI for scheduling the simultaneous transmission of the plurality of PUSCHs. The capability of simultaneous transmission of the plurality of PUSCHs may include at least one of: the plurality of PUSCHs is completely non-overlapped in frequency domain but at least partially overlapped in time domain; the plurality of PUSCHs is fully overlapped in both time and frequency domain; and the plurality of PUSCHs is partially overlapped in both time and frequency domain.

A method for a network device according to some embodiments of the present disclosure may comprise generating a plurality of downlink control information (DCI) for scheduling a simultaneous transmission of a plurality of physical uplink shared channels (PUSCHs) of a wireless device; and sending the plurality of DCI to the wireless device. The simultaneous transmission is configured by the plurality of DCI so that the plurality of PUSCHs to be transmitted by the wireless device are at least partially overlapped in time domain.

A method for a wireless device according to some embodiments of the present disclosure may comprise reporting, to a network device, a capability of simultaneous transmission of a plurality of physical uplink shared channels (PUSCHs); and receiving, from the network device, a plurality of downlink control information (DCI) for scheduling the simultaneous transmission of the plurality of PUSCHs. The capability of simultaneous transmission of the plurality of PUSCHs includes at least one of: the plurality of PUSCHs is completely non-overlapped in frequency domain but at least partially overlapped in time domain; the plurality of PUSCHs is fully overlapped in both time and frequency domain; and the plurality of PUSCHs is partially overlapped in both time and frequency domain.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example method for a network device which schedules a multi-DCI based simultaneous PUSCH transmission according to some embodiments disclosed herein.

FIG. 4 illustrates an example multi-panel structure of a wireless device according to some embodiments disclosed herein.

FIG. 5 illustrates an example time-frequency resource diagram of spatial domain multiplexing (SDM) and frequency domain multiplexing (FDM) according to some embodiments disclosed herein.

FIG. 6 illustrates an example method for a wireless device which performs a multi-DCI based simultaneous PUSCH transmission according to some embodiments disclosed herein.

FIG. 7 illustrates an example time-frequency resource diagram of simultaneous PUSCH transmission scenarios according to some embodiments disclosed herein.

FIG. 8 illustrates an example signaling diagram between a network device and a wireless device for a multi-DCI based simultaneous PUSCH transmission according to some embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

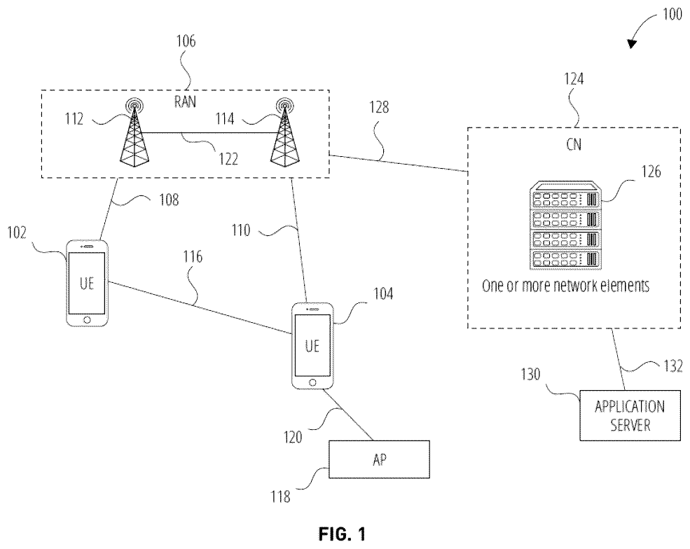

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications or uplink communication or ProSe or sidelink communication) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

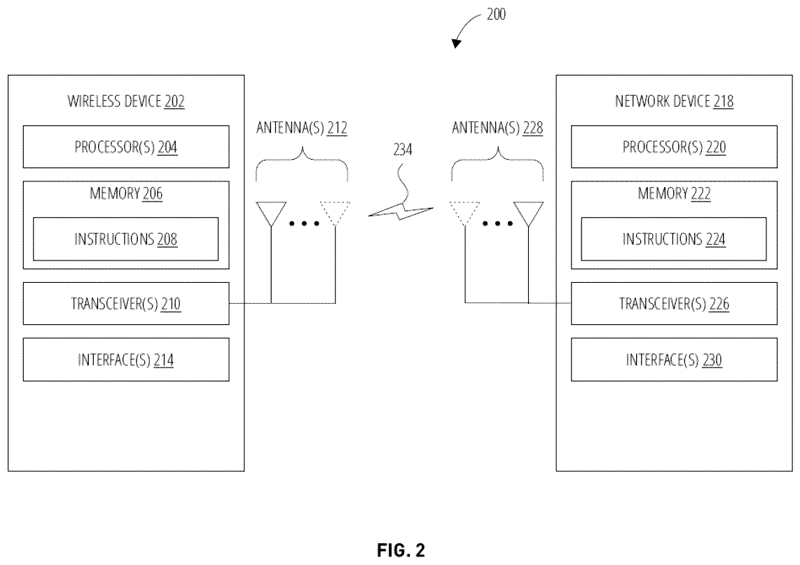

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

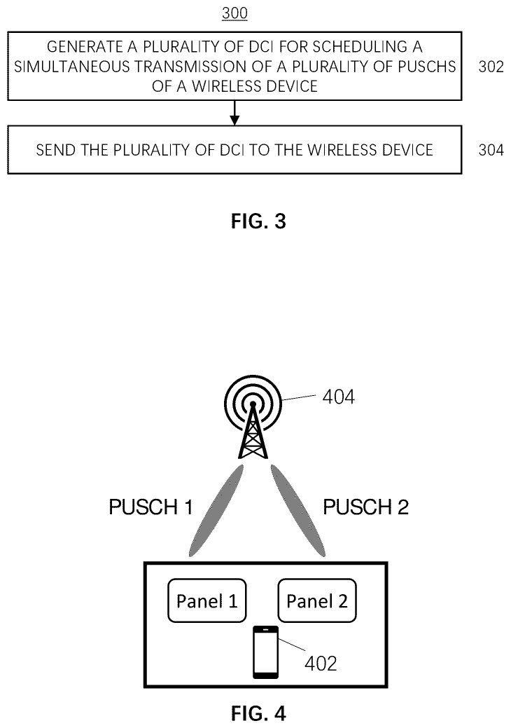

Now refer to FIG. 3, an example method 300 for a network device which schedules a multi-DCI based simultaneous PUSCH transmission according to some embodiments disclosed herein will be described.

In 302, the network device generates a plurality of downlink control information DCI for scheduling a simultaneous transmission of a plurality of PUSCHs of a wireless device. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

The simultaneous transmission is configured by the network device using the plurality of DCI so that the plurality of PUSCHs to be transmitted by the wireless device are at least partially overlapped in time domain. In some embodiments, each of the plurality of DCI may be used by the wireless device to configure a respective PUSCH of the plurality of PUSCHs.

In this disclosure, simultaneous transmission of a plurality of PUSCHs means that the plurality of PUSCHs are at least partially overlapped in time domain when being transmitted. In some embodiments, the simultaneous transmission of the plurality of PUSCHs may be achieved by the multi-panel structure of the wireless device.

FIG. 4 illustrates an example multi-panel structure of a wireless device. The wireless device 402 includes two antenna panels, i.e., panel 1 and panel 2. There are two PUSCHs, i.e., PUSCH 1 and PUSCH 2 shown in FIG. 4 to be simultaneously transmitted to the network device 404. By using the multi-panel structure of wireless device 402, each of the two PUSCHs may be transmitted by a respective antenna panel of the wireless device, so as to achieve the simultaneous transmission. For example, as shown in FIG. 4, PUSCH 1 may be transmitted by panel 1 and PUSCH 2 may be transmitted by panel 2.

In 304, the network device sends the plurality of DCI to the wireless device to configure the wireless device to perform the simultaneous PUSCH transmission.

According to the present disclosure, a multi-DCI based simultaneous PUSCH transmission may be achieved which may help to increase the uplink transmission throughput and reliability.

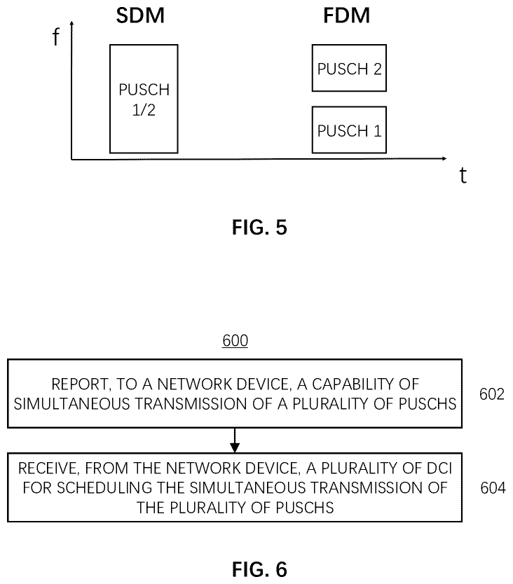

The present disclosure may be applied to a simultaneous PUSCH transmission in which the plurality of PUSCHs are at least partially overlapped in time domain while there are no restrictions for the overlapping of the plurality of PUSCHs in frequency domain. There may be mainly two ways to achieve the simultaneous PUSCH transmission, one is spatial domain multiplexing (SDM), the other is frequency domain multiplexing (FDM). FIG. 5 illustrates an example time-frequency resource diagram of SDM and FDM, in which the horizontal axis denotes time domain, and the vertical axis denotes frequency domain. Assuming that PUSCH 1 and PUSCH 2 are to be simultaneously transmitted, for SDM, PUSCH 1 and PUSCH 2 are to be distinguished in spatial domain (e.g., transmitted in different antenna beams), and thus they may occupy the same time-frequency resources. For FDM, PUSCH 1 and PUSCH 2 are to be distinguished in frequency domain (e.g., transmitted in different frequency bands), and thus they may occupy the same time resources.

When scheduling the simultaneous transmission of the plurality of PUSCHs, from the perspective of lowering power control complexity, decreasing system overhead, reducing heating, and/or cost saving, etc., some restrictions may be considered. Some exemplary restrictions will be described below in detail.

Restrictions on Overlapping of PUSCHs in Time Domain and/or Frequency Domain

In some embodiments, some restrictions for the overlapping of the plurality of PUSCHs in time domain and/or frequency domain may be considered.

For a restriction in time domain, in some embodiments, the simultaneous transmission may be configured by the network device using the plurality of DCI so that the plurality of PUSCHs are completely overlapped in time domain. Since the plurality of PUSCHs are restricted to be completely overlapped in time domain, for example, the power control complexity at the wireless device side may be decreased.

For restrictions in frequency domain, as option 1, in some embodiments, the simultaneous transmission may be configured by the network device using the plurality of DCI so that the plurality of PUSCHs are non-overlapped in frequency domain. In this way, frequency domain multiplexing (FDM) is applied to the plurality of PUSCHs. Since the plurality of PUSCHs are non-overlapped in frequency domain, they are not interfered with each other even if they are overlapped in time domain.

For restrictions in frequency domain, as option 2, in some embodiments, the simultaneous transmission may be configured by the network device using the plurality of DCI so that the plurality of PUSCHs are completely overlapped in frequency domain. In this case, the plurality of PUSCHs are overlapped in both frequency and time domain, and further spatial domain multiplexing (SDM) may be applied to avoid interference.

For restrictions in frequency domain, as option 3, as a combination of the above two options, in some embodiments, the simultaneous transmission may be configured by the network device using the plurality of DCI so that the plurality of PUSCHs are either non-overlapped in frequency domain or completely overlapped in frequency domain.

In some embodiments, the network device may consider the above restrictions to generate the plurality of DCI to configure the wireless device to perform simultaneous PUSCH transmission. For example, the network device may choose one option from the above options 1 to 3 to configure the overlapping of the plurality of PUSCHs in frequency domain.

It is noted that although three options for the frequency domain overlapping are described, other options may be designed according to actual practice. For example, an additional option may be that the plurality of PUSCHs are partially overlapped in frequency domain.

### Restrictions on Priority of the PUSCHs

A PUSCH transmission may be associated with different priorities. For example, a priority of a PUSCH may include a high priority and a low priority. In case of network congestion or low channel quality, the PUSCH with low priority may possibly be dropped while the PUSCH with high priority may be kept as far as possible. For example, DCI may include a one-bit field indicating the priority of the PUSCH to be scheduled.

In some embodiments, the simultaneous transmission may be configured by the network device using the plurality of DCI so that the plurality of PUSCHs have the same priority. For example, all simultaneously transmitted PUSCHs may be configured to have high priority, or all simultaneously transmitted PUSCHs may be configured to have low priority. By configuring the plurality of PUSCHs as having the same priority, processing complexity of the wireless device may be lowered.

In some other embodiments, the simultaneous transmission may be configured by the network device using the plurality of DCI so that different priorities can be allowed for the plurality of PUSCHs in a simultaneous transmission, so as to meet different requirements in PUSCH transmission.

### Restrictions on Timing Advance (TA) of the PUSCHs

Timing advance is a media access control-control element (MAC-CE) that is used to control uplink signal (such as PUSCH) transmission timing. The network device may keep measuring the time difference between PUSCH reception and the subframe time and can send a TA command to the wireless device to change the PUSCH transmission to make it better aligned with the subframe timing at the network device side. If a PUSCH arrives at the network device too early, the network device may send a TA command to the wireless device with a smaller timing advance. If a PUSCH arrives at the network device too late, the network device may send a TA command to the wireless device with a larger timing advance.

In some embodiments, the simultaneous transmission may be configured by the network device using the plurality of DCI so that the plurality of PUSCHs have the same TA. This may ensure that the simultaneously transmitted PUSCHs are aligned at the initial transmission to decrease the interferences which may occur among the simultaneous transmission of these PUSCHs. Further, the processing complexity of the wireless device may be lowered if the same TA is configured. Further, even if two simultaneously transmitted PUSCHs are to be received by different network devices, the difference between a propagation delay of one PUSCH and a propagation delay of another PUSCH can be regarded as small enough to be ignored. Therefore, there may be almost no impact on receivers (e.g. different network devices) in the case that the simultaneously transmitted PUSCHs have the same TA.

### Restrictions on Uplink Operation Mode of the PUSCHs

The uplink operation mode may include a codebook based uplink operation mode and a non-codebook based uplink operation mode. For codebook based uplink operation mode, a PUSCH is transmitted based on single SRS (sounding reference signal) resource with multiple antenna ports, and the network device schedules the PUSCH by indicating the transmit precoding matrix (TPMI) and rank indication (RI). For non-codebook based uplink operation mode, a PUSCH is transmitted based on multiple SRS resources each with a single antenna port, and the network device schedules the PUSCH by indicating the SRS resource selection.

In some embodiments, the simultaneous transmission may be configured by the network device using the plurality of DCI so that the plurality of PUSCHs are in the same uplink operation mode. For example, all of the plurality of PUSCHs may be configured in the codebook based uplink operation mode. Alternatively, all of the plurality of PUSCHs may be configured in the non-codebook based uplink operation mode. This may lower the processing complexity of the wireless device.

In some embodiments, in the case that the plurality of PUSCHs are configured in the codebook based uplink operation mode, the simultaneous transmission may be further configured by the network device using the plurality of DCI so that the plurality of PUSCHs follow the same coherency configuration. The coherency configuration indicates a sub-mode under the codebook based uplink operation mode and may include a full coherent configuration, a partial coherent configuration and a non-coherent configuration. The full coherency configuration is compatible with the partial and non-coherency configuration and may be called “fullyAndPartialAndNonCoherent”. The partial coherency configuration is compatible with the non-coherency configuration and may be called “partialAndNonCoherent”. Further, the non-coherency configuration may be called “nonCoherent”. By configuring the plurality of PUSCHs to follow the same coherency configuration, the processing complexity of the wireless device may be further lowered.

### Restrictions on the Number of Simultaneously Transmitted PUSCHs

In some embodiments, from the perspective of cost saving, power consumption, processing complexity, heating problem, etc, the plurality of PUSCHs scheduled in the simultaneous transmission may be limited to include at most two PUSCHs. In other words, in the simultaneous transmission, two PUSCHs are scheduled to be transmitted simultaneously.

### Restrictions on Demodulation Reference Signal (DMRS) of the PUSCHs

DMRS symbol(s) are carried in each PUSCH and may be used for uplink channel estimation. In particular, DMRS symbol(s) with a specific pattern may be carried by the PUSCH and transmitted from the wireless device to the network device. The network device may use the received DMRS symbol(s) with the specific pattern, which is known by the network device in advance, for estimating the uplink channel. In the following description, the design of specific pattern of DMRS symbol(s) for the plurality of simultaneously transmitted PUSCHs will be described.

For the case that the plurality of PUSCHs are configured by the network device using the plurality of DCI as being not overlapped in frequency domain (such as the above described overlapping option 1 in frequency domain), interferences among the plurality of PUSCHs in frequency domain will not occur. Therefore, in this situation, the DMRS patterns of the plurality of PUSCHs may be arbitrarily designed.

For the case that the plurality of PUSCHs are configured by the network device using the plurality of DCI as being at least partially overlapped in frequency domain, it is possible that the DMRS symbols of one PUSCH are interfered by the uplink data carried by another PUSCH. In order to avoid this interference, in some embodiments, the network device may use the plurality of DCI to configure the DMRS symbols in different PUSCHs to be aligned with each other. The alignment may be achieved by following at least one of the designs to be described below.

Specifically, for a first design, the plurality of PUSCHs may have the same number of front-loaded DMRS symbols (e.g, each PUSCH having one DMRS symbol, or each PUSCH having two DMRS symbols). In a resource block (RB), the number of front-loaded DMRS symbols may be differently defined. This first design restricts the actual number of front-loaded DMRS symbols for each of the plurality of PUSCHs to be the same.

In a second design, the plurality of PUSCHs may have the same number of additional DMRS symbols. The additional DMRS symbols may be configured in the RB to facilitate more accurate channel estimation. This second design in combination with the first design may ensure that the total number of DMRS symbols used in each of the PUSCHs are the same.

In a third design, the plurality of PUSCHs may have the same DMRS symbol locations. Depending on different mapping type of DMRS symbols, the DMRS symbol locations (either the front-loaded DMRS symbols or the addition DMRS symbols in RB in time domain) may differ. Therefore, the third design may ensure that the DMRS symbols in each of the plurality of PUSCHs are aligned in the same locations of the RB.

In a fourth design, the plurality of PUSCHs may have the same DMRS configuration type. There are mainly two DMRS configuration types 1 and 2 defining different mappings of DMRS in resource elements in frequency domain. By further configuring the same DMRS configuration type for each of the plurality of PUSCHs, the DMRS symbols may be aligned more accurately.

In the present disclosure, by aligning the DMRS symbols in simultaneously transmitted PUSCHs, the receiver (e.g., the network device) may be easier to distinguish the DMRS symbols from the uplink data carried by each PUSCH, so as to simplify the receiving algorithm in the receiver.

### Restrictions on Orthogonal Frequency Division Multiplexing (OFDM) Waveform of the PUSCHs

The OFDM waveform may include a DFT-s-OFDM (Discrete Fourier Transform (DFT)-spread-OFDM), which is transform precoding enabled, and a CP-OFDM (Circular Prefix-OFDM) which is transform precoding disabled.

In some embodiments, the simultaneous transmission may be configured by the network device using the plurality of DCI so that the plurality of PUSCHs are to be transmitted by the same OFDM waveform.

### Restrictions on Maximum Number of PUSCH Hybrid Automatic Repeat Request (HARQ) Processes

In some embodiments, the simultaneous transmission may be configured by the network device using the plurality of DCI so that a maximum number of PUSCH HARQ processes for the plurality of PUSCHs are the same as a maximum number of legacy PUSCH HARQ processes.

It is noted that the wording “legacy” described herein means any existing scheme before the present disclosure, including but not limited to any scheme related to the LTE system standards and/or 5G or NR system standards as provided by 3GPP technical specifications.

For example, the maximum number of legacy PUSCH HARQ processes may be 16, and the maximum number of PUSCH HARQ processes for the plurality of PUSCHs may also be set as 16, so as not to increase any storage burden as compared to the legacy device.

In some embodiments, the network may support more than 16 PUSCH HARQ processes, such as 32 PUSCH HARQ processes, etc. In this case, the network device may receive additional capability report from the wireless device which shows the capability of maximum supportable PUSCH HARQ processes of the wireless device (e.g., 32 HARQ processes supportable). The network device may determine the maximum number of PUSCH HARQ processes for the plurality of PUSCHs based on the received additional capability reporting.

In the above description, several restrictions when scheduling the simultaneous PUSCH transmission are discussed. It is noted that the restrictions described herein may be individually applied, or multiple restrictions may be applied together.

Now refer to FIG. 6, an example method 600 for a wireless device which performs a multi-DCI based simultaneous PUSCH transmission according to some embodiments disclosed herein will be described.

In 602, the wireless device reports, to a network device, a capability of simultaneous transmission of a plurality of PUSCHs. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

In some embodiments, the capability of simultaneous transmission of the plurality of PUSCHs may include at least one of: (1) the plurality of PUSCHs are completely non-overlapped in frequency domain but at least partially overlapped in time domain; (2) the plurality of PUSCHs are fully overlapped in both time and frequency domain; and (3) the plurality of PUSCHs are at least partially overlapped in both time domain and frequency domain.

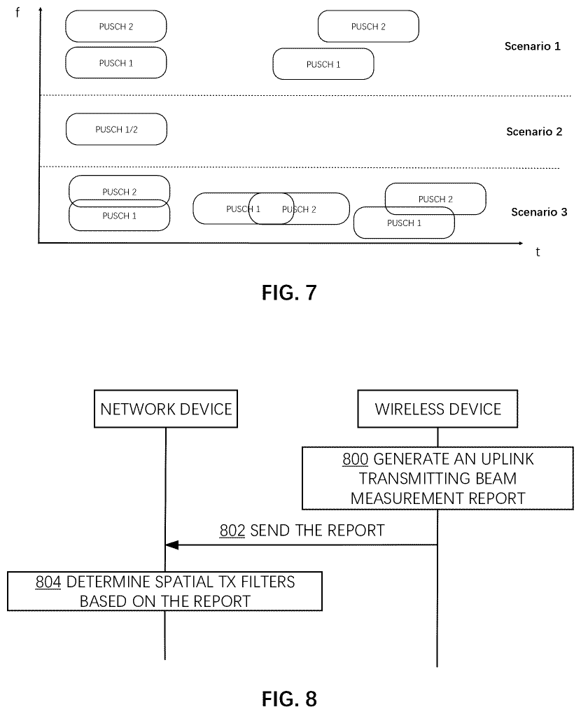

FIG. 7 illustrates an example time-frequency resource diagram of simultaneous PUSCH transmission scenarios according to some embodiments disclosed herein, in which the horizontal axis denotes time domain, and the vertical axis denotes frequency domain. The scenarios shown in FIG. 7 may correspond to the above-described capabilities (1) to (3).

Specifically, scenario 1 in FIG. 7 corresponds to the first capability that the plurality of PUSCHs are completely non-overlapped in frequency domain but at least partially overlapped in time domain. The left of scenario 1 shows that PUSCHs 1 and 2 are completely non-overlapped in frequency domain and are fully overlapped in time domain. The right of scenario 1 shows that PUSCHs 1 and 2 are completely non-overlapped in frequency domain and are partially overlapped in time domain.

Scenario 2 in FIG. 7 corresponds to the second capability that the plurality of PUSCHs (corresponding to PUSCHs 1 and 2 shown in FIG. 7) are fully overlapped in both time and frequency domain.

Scenario 3 in FIG. 7 corresponds to the third capacity that the plurality of PUSCHs are at least partially overlapped in both time and frequency domain. The left of scenario 3 shows that PUSCH 1 and PUSCH 2 are partially overlapped in frequency domain and are partially overlapped in time domain. The middle of scenario 3 shows that PUSCH 1 and PUSCH 2 are fully overlapped in frequency domain and are partially overlapped in time domain. The right of scenario 3 shows that PUSCH 1 and PUSCH 2 are partially overlapped in both frequency and time domains.

In 604, the wireless device receives, from the network device, a plurality of DCI for scheduling the simultaneous transmission of the plurality of PUSCHs. The plurality of DCI may be determined by the network device based on the capability of simultaneous transmission of the plurality of PUSCHs reported by the wireless device, so as to configure the wireless device to perform a supportable simultaneous transmission.

In legacy PUSCH transmission, a maximum number of PUSCH layers that the wireless device can support is reported from the wireless device to the network device. The maximum number of PUSCH layers indicates the maximum number of layers that one PUSCH can be transmitted from the wireless device.

Depending on different band combinations, different bands, and different component carriers, the maximum number of PUSCH layers may differ. The maximum number of PUSCH layers that the wireless device can support may be reported as per feature set per component carrier (FSPC), that is, per component carrier per band per band combination. In legacy systems, for codebook based PUSCH operation, the maximum number of PUSCH layers is reported in “maxNumberMIMO-LayersCB-PUSCH”. For non-codebook based PUSCH operation, the maximum number of PUSCH layers is reported in “maxNumberMIMO-LayersNonCB-PUSCH”.

The above legacy report of maximum number of PUSCH layers may still work in the case that the plurality of PUSCHs are configured by the network device using the plurality of DCI as being not overlapped in frequency domain (such as the above described overlapping option 1 in frequency domain), because different PUSCHs does not share any resource element in frequency domain.

However, in the case that the plurality of PUSCHs are configured by the network device using the plurality of DCI as being partially overlapped in frequency domain (e.g, at least two PUSCHs share at least one resource element in frequency domain), the legacy report of “maxNumberMIMO-LayersCB-PUSCH” or “maxNumberMIMO-LayersNonCB-PUSCH” may not applicable, because the maximum number of supportable PUSCH layers per FSPC may change when there are partially overlapping in frequency domain.

In some embodiments, instead of reporting “maxNumberMIMO-LayersCB-PUSCH” or “maxNumberMIMO-LayersNonCB-PUSCH”, the wireless device may report, to the network device, a set of maximum number of layers for the plurality of PUSCHs that the wireless device is able to support. For example, in the case that two PUSCHs are scheduled to be simultaneously transmitted, and the PUSCH operation mode is configured as “codebook based uplink operation mode”, the wireless device may report a set (pair) of (maxNumberMIMO-LayersCB-PUSCH1, maxNumberMIMO-LayersCB-PUSCH2) to the network device. In the pair, “maxNumberMIMO-LayersCB-PUSCH1” indicates the maximum number of layers for the first PUSCH, and “maxNumberMIMO-LayersCB-PUSCH2” indicates the maximum number of layers for the second PUSCH. Similarly, in the case that the two simultaneously transmitted PUSCHs are configured as “non-codebook based uplink operation mode”, the wireless device may report a set (pair) of (maxNumberMIMO-LayersNonCB-PUSCH1, maxNumberMIMO-LayersNonCB-PUSCH2) to the network device.

In some embodiments, instead of reporting only one set of maximum numbers of layers, the wireless device may alternatively report multiple sets of maximum numbers of layers that each PUSCH can support. For example, the wireless may report two sets of (maxNumberMIMO-LayersCB-PUSCH1=2, maxNumberMIMO-LayersCB-PUSCH2=1) and (maxNumberMIMO-LayersCB-PUSCH1=1, maxNumberMIMO-LayersCB-PUSCH2=2). The network device, when receiving the report of the two sets, may choose one set and generate the plurality of DCI based on the chosen set. Further, similar as the legacy transmission, the one or more sets of maximum numbers of layers may be reported as per FSPC.

In some embodiments, a legacy maximum number L of PUSCH layers can be reused for reporting the maximum numbers of layers of the plurality of simultaneously transmitted PUSCHs.

In the case that the plurality of PUSCHs are configured by the network device using the plurality of DCI as being not overlapped in frequency domain (such as the above described overlapping option 1 in frequency domain), the legacy maximum number L may be directly applied, because different PUSCHs does not share any resource element in frequency domain.

However, in the case that the plurality of PUSCHs are configured by the network device using the plurality of DCI as being partially overlapped in frequency domain (e.g, at least two PUSCHs share at least one resource element in frequency domain), the legacy maximum number L may not be directly applied. Some interpretations may be made to the legacy maximum number L so that this number may be reused to indicate the maximum numbers of layers of the plurality of simultaneously transmitted PUSCHs.

In some embodiments, the legacy maximum number L may be interpreted as L is an upper limit of a sum of the numbers of layers of the plurality of PUSCHs. For example, as shown in the following table 1, assuming that the number of layers of PUSCH1 is R1 and the number of layers of PUSCH2 is R2, when the legacy maximum number L (e.g., maxNumberMIMO-LayersCB-PUSCH=L or maxNumberMIMO-LayersNonCB-PUSCH=L) is reported by the wireless device, it means that “R1+R2≤L” should be satisfied.

In some embodiments, the legacy maximum number L may be interpreted as L is an upper limit of the number of layers of each of the plurality of PUSCHs. For example, as shown in the following table 1, this interpretation of L means that “R1≤L and R2≤L” should be satisfied.

In some embodiments, the legacy maximum number L may be interpreted as floor of L/2 is an upper limit of the number of layers of each of the plurality of PUSCHs. For example, as shown in the following table 1, this interpretation of L means that “R1≤floor (L/2) and R2≤floor (L/2)” should be satisfied.

In some embodiments, the legacy maximum number L may be interpreted as ceiling of L/2 is an upper limit of the number of layers of each of the plurality of PUSCHs and L is an upper limit of a sum of the numbers of layers of the plurality of PUSCHs. For example, as shown in the following table 1, this interpretation of L means that “R1≤ceiling (L/2) and R2≤ceiling (L/2), and R1+R1≤L” should be satisfied.

TABLE 1
Wireless device reported
maxNumberMIMO-LayersCB-PUSCH/
maxNumberMIMO-LayersNonCB-PUSCH = L

| | |
|---|---|
| PUSCH 1 | PUSCH 2 |
| Number of layers R1 | Number of layers R2 |

| | |
|---|---|
| Interpretation 1 | R1 + R1 ≤ L |
| Interpretation 2 | R1 ≤ L and R2 ≤ L |
| Interpretation 3 | R1 ≤ floor(L/2) and R2 ≤ floor(L/2) |
| Interpretation 4 | R1 ≤ ceiling(L/2) and R2 ≤ ceiling(L/2), |
| | and R1 + R1 ≤ L |

In some embodiments, the wireless device may report to the network device which interpretation of the legacy maximum number L is used. For example, for a total of four interpretations as shown in Table 1, a two-bit information may be used for indicating the interpretation number and sent to the network device.

When scheduling the simultaneous transmission of the plurality of PUSCHs, spatial transmitting filters (spatial Tx filters, or named “analog Tx beams”) used for transmitting the plurality of PUSCHs may be properly determined. Due to the multi-panel structure of the wireless device for supporting simultaneous transmission, for each antenna panel used for simultaneous transmission of one PUSCH, not all spatial filters can be used but only a part of the spatial filters may be used by one antenna panel. In this case, the wireless device should report to the network device which spatial filters may be used for which antenna panel.

In some embodiments, the plurality of spatial Tx filters may be the same as the spatial receiving filters (spatial Rx filters).

For downlink receiving of one or more physical downlink shared channels (PDSCH), the wireless device may send a downlink receiving beam measurement report to the network device which may contain one or more sets of spatial Rx filters that are able to be used by the wireless device for simultaneous downlink reception.

For example, for simultaneously receiving two PDSCHs, a set (pair) of spatial Rx filters (1, 7) may be contained in the downlink receiving beam measurement report, which means that the spatial Rx filters No. 1 and No. 7 may be used for simultaneously receiving the two PDSCH. The set of spatial Rx filters may be the spatial filters which are used for receiving the set of QCL (quasi co-location) reference signals. Further, multiple sets of spatial RX filters (such as (1, 7), (2, 10), (3, 11)) may be contained in the report which indicate candidate sets of spatial Rx filters.

For uplink transmitting of the plurality of PUSCHs, the network device may determine the plurality of spatial Tx filters based on the downlink receiving beam measurement report. For example, if spatial Rx filters No. 1 and No. 7 are reported in the downlink receiving beam measurement report, the spatial Tx filters No. 1 and No. 7 may be determined by the network device as the spatial Tx filters. Further, if multiple sets of spatial Rx filters (such as (1, 7), (2, 10), (3, 11)) are reported, the network device may determine one set from the multiple sets as the set of spatial Tx filters.

However, in some cases, such as for the purpose of power saving, processing complexity saving, the number of antenna panels used for downlink and uplink may be different, the number of downlink panels may be more than the number of uplink panels. In these cases, the spatial Rx filters used for simultaneous downlink receiving may not be similarly applied for spatial Tx filters used for simultaneous uplink transmitting. Therefore, a separate uplink transmitting beam measurement report and corresponding signaling between the network device and the wireless device may be designed. This will be described in detail with reference to FIG. 8.

FIG. 8 illustrates an example signaling diagram between a network device and a wireless device for a multi-DCI based simultaneous PUSCH transmission according to some embodiments disclosed herein. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

In 800, the wireless device may generate an uplink transmitting beam measurement report. The uplink transmitting beam measurement report may contain one or more sets of spatial Tx filters that are able to be used by the wireless device for simultaneously transmitting the plurality of PUSCHs. For example, the report may include multiple sets of spatial Tx filters (1, 8), (2, 9), (3, 11) which are able to be used for simultaneously transmitting two PUSCHs.

In 802, the wireless device may send the uplink transmitting beam measurement report to the network device.

In 804, the network device may receive the uplink transmitting beam measurement report and determine the plurality of spatial Tx filters based on the received report. For example, the network device may determine one set of spatial Tx filters from the multiple sets (1, 8), (2, 9), (3, 11) contained in the report. Then, the network device may generate the plurality of DCI based on the determined set of spatial Tx filters and send the plurality of DCI to the wireless device for scheduling the simultaneous transmission of the two PUSCHs.

Embodiments contemplated herein include an apparatus comprising means to perform one or more elements of the methods illustrated in FIGS. 3 and 6, or one or more elements of the signaling illustrated in FIG. 58. This apparatus may be, for example, an apparatus of a base station (such as a network device 218 that is a base station, as described herein) or an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the methods illustrated in FIGS. 3 and 6, or one or more elements of the signaling illustrated in FIG. 8. This non-transitory computer-readable media may be, for example, a memory of a base station (such as a memory 222 of a network device 218 that is a base station, as described herein) or a memory of a UE (such as a memory 206 of a wireless device 202 that is a UE, as described herein).

Embodiments contemplated herein include an apparatus comprising logic, modules, or circuitry to perform one or more elements of the methods illustrated in FIGS. 3 and 6, or one or more elements of the signaling illustrated in FIG. 8. This apparatus may be, for example, an apparatus of a base station (such as a network device 218 that is a base station, as described herein) or an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the methods illustrated in FIGS. 3 and 6, or one or more elements of the signaling illustrated in FIG. 8. This apparatus may be, for example, an apparatus of a base station (such as a network device 218 that is a base station, as described herein) or an apparatus of a UE (such as a wireless device 202 that is a UE, as described herein).

Embodiments contemplated herein include a signal as described in or related to one or more elements of the methods illustrated in FIGS. 3 and 6, or one or more elements of the signaling illustrated in FIG. 8.

Embodiments contemplated herein include a computer program or computer program product comprising instructions, wherein execution of the program by a processing element is to cause the processing element to carry out one or more elements of the methods illustrated in FIGS. 3 and 6, or one or more elements of the signaling illustrated in FIG. 8. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein). The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A network device, comprising:
a transceiver;
a memory, in which instructions are stored; and
at least one processor, configured to execute the instructions stored in the memory to cause the network device to:
generate a plurality of downlink control information (DCI) for scheduling a simultaneous transmission of a plurality of physical uplink shared channels (PUSCHs) from a wireless device; and
send, via the transceiver, the plurality of DCI to the wireless device.

2. The network device of claim 1, wherein the simultaneous transmission is configured by the plurality of DCI so that
the plurality of PUSCHs are either non-overlapped in a frequency domain or completely overlapped in the frequency domain.

3. The network device of claim 1, wherein the simultaneous transmission is configured by the plurality of DCI so that the plurality of PUSCHs are completely overlapped in a time domain.

4. The network device of claim 1, wherein the simultaneous transmission is configured by the plurality of DCI to use a plurality of spatial transmitting filters determined based on a downlink receiving beam measurement report.

5. The network device of claim 1, wherein the simultaneous transmission is configured by the plurality of DCI to use a plurality of spatial transmitting filters determined based on an uplink transmitting beam measurement report.

6. The network device of claim 1, wherein the simultaneous transmission is configured by the plurality of DCI so that the plurality of PUSCHs have a same priority.

7. (canceled)

8. The network device of claim 1, wherein the simultaneous transmission is configured by the plurality of DCI so that the plurality of PUSCHs have a same timing advance (TA).

9. The network device of claim 1, wherein the simultaneous transmission is configured by the plurality of DCI so that the plurality of PUSCHs are in a same uplink operation mode.

10. (canceled)

11. The network device of claim 1, wherein the simultaneous transmission includes at most two PUSCHs.

12. The network device of claim 1, wherein when the plurality of PUSCHs are configured to be at least partially overlapped in a frequency domain, the simultaneous transmission is further configured by the plurality of DCI so that at least one of the following is satisfied:
the plurality of PUSCHs have a same number of front-loaded demodulation reference signal (DMRS) symbols;
the plurality of PUSCHs have a same number of additional DMRS symbols;
the plurality of PUSCHs have a same DMRS symbol locations; and
the plurality of PUSCHs have a same DMRS configuration type.

13. The network device of claim 1, wherein the simultaneous transmission is configured by the plurality of DCI so that the plurality of PUSCHs are to be transmitted by a same orthogonal frequency division multiplexing (OFDM) waveform.

14. The network device of claim 1, wherein the simultaneous transmission is configured by the plurality of DCI so that a maximum number of PUSCH hybrid automatic repeat request (HARQ) processes for the plurality of PUSCHs is a same as a maximum number of legacy PUSCH HARQ processes.

15. The network device of claim 1, wherein the simultaneous transmission is configured by the plurality of DCI so that a maximum number of PUSCH HARQ processes for the plurality of PUSCHs are determined based on a capability report from the wireless device.

16. (canceled)

17. A wireless device, comprising:
a transceiver;
a memory, in which instructions are stored; and
at least one processor, configured to execute the instructions stored in the memory to cause the wireless device to:
report, to a network device and via the transceiver, a capability of simultaneous transmission of a plurality of physical uplink shared channels (PUSCHs); and
receive, from the network device and via the transceiver, a plurality of downlink control information (DCI) generated based on the capability of simultaneous transmission and for scheduling the simultaneous transmission of the plurality of PUSCHs.

18. (canceled)

19. The wireless device of claim 17, wherein when the plurality of PUSCHs are configured by the plurality of DCI to be at least partially overlapped in a frequency domain, the at least one processor is further configured to execute the instructions stored in the memory to:
report, to the network device and via the transceiver, one or more sets of maximum numbers of layers for the plurality of PUSCHs that the wireless device is able to support.

20. The wireless device of claim 17, wherein when the plurality of PUSCHs are configured by the plurality of DCI to be at least partially overlapped in a frequency domain, the at least one processor is further configured to execute the instructions stored in the memory to:
report, to the network device and via the transceiver, a legacy maximum number L of PUSCH layers supported by the wireless device, wherein the legacy maximum number L is interpreted as one of the following:
L is an upper limit of a sum of numbers of layers of the plurality of PUSCHs;
L is an upper limit of a number of layers of each of the plurality of PUSCHs;
floor of L/2 is an upper limit of the number of layers of each of the plurality of PUSCHs; and
ceiling of L/2 is an upper limit of the number of layers of each of the plurality of PUSCHs and L is an upper limit of a sum of the numbers of layers of the plurality of PUSCHs.

21. (canceled)

22. A method for a network device, comprising:
generating a plurality of downlink control information (DCI) for scheduling a simultaneous transmission of a plurality of physical uplink shared channels (PUSCHs) from a wireless device; and
sending the plurality of DCI to the wireless device.

23-25. (canceled)

26. The wireless device according to claim 17, wherein the capability of simultaneous transmission of the plurality of PUSCHs includes an indication of whether the wireless device supports the plurality of PUSCHs being completely non-overlapped in a frequency domain but at least partially overlapped in a time domain.

27. The wireless device according to claim 17, wherein the capability of simultaneous transmission of the plurality of PUSCHs includes an indication of whether the wireless device supports the plurality of PUSCHs being fully overlapped in both a time domain and a frequency domain.

28. The wireless device according to claim 17, wherein the capability of simultaneous transmission of the plurality of PUSCHs includes an indication of whether the wireless device supports the plurality of PUSCHs being partially overlapped in both a time domain and a frequency domain.
